(19) United States
(12) Patent Application Publication
(10) Pub. No.: US 2008/0093435 A1
(43) Pub. Date: Apr. 24, 2008

(54) MECHANICAL GOLF COUNTER

(75) Inventor: Vincent Berseth, Neuchatel (CH)

Correspondence Address: GRIFFIN & SZIPL, PC, SUITE PH-1, 2300 NINTH STREET, SOUTH, ARLINGTON, VA, 22204, US

(73) Assignee: THE SWATCH GROUP RESEARCH AND DEVELOPMENT LTD, Marin (CH)

(21) Appl. No.: 11/772,594

(22) Filed: Jul. 2, 2007

(30) Foreign Application Priority Data
Jun. 30, 2006 (EP) 06116401.8

(51) Int. Cl. A63B 71/04; G04B 47/06

(52) U.S. Cl. 235/123; 368/10

(57) ABSTRACT

A mechanical golf counter includes a case in which is mounted a golf counter mechanism including: a plurality of first means for counting score associated with a plurality of holes, and for providing indication of the score at each hole; a plurality of second means for storing the indication for each hole, and cooperating with the first means; third means for altering the score indication of a selected hole, the third means cooperating with the first means; fourth means for reading the score of the selected hole, the fourth means cooperating with the first means; and fifth means for displaying the score of the selected hole, the fifth means cooperating with the fourth means, wherein the first means are mounted mobile inside the case so any one of the means can occupy a determined score incrementing/read position, in which the means is selected to cooperate with the third and fourth means.

The present invention relates to the field of mechanics and horology. It concerns more specifically a mechanical golf counter able to be integrated in a mechanical watch.

Such golf counters have already been disclosed, particularly in GB Patent Nos. 309 613 and 310 401. These documents disclose mechanical golf counters, simultaneously displaying the score at all of the holes, but not allowing display of the time, because of their design. In parallel, there exist watches fitted with mechanical golf counters that display the score at the hole being played and the total score. This type of watch is certainly very useful for the golfer. However, the information concerning the number of strokes played for a hole is lost at the next hole. The player thus cannot return to the number of strokes played for a given hole and analyse his round hole by hole. Such devices are disclosed in EP Patent No. 1 099 459 and WO 00/54116.

The present invention overcomes these drawbacks by proposing a mechanical golf counter fitted with a device for counting and storing the score at each hole, and a device for displaying the score at any selected hole.

More specifically, the invention concerns a mechanical golf counter comprising a case in which there is mounted a golf counter mechanism including:

a plurality of first means for counting a score associated with a plurality of holes, and able to provide an indication of the score at each hole, and

a plurality of second means able to store this indication for each hole, and cooperating with said first means, the golf counter mechanism being characterized in that it further comprises:

third means able to alter the indication of the score of a selected hole, said third means cooperating with the first means,

fourth means able to read the score of the selected hole, said fourth means cooperating with the first means,

fifth means able to display the score of the selected hole, said fifth means cooperating with the fourth means,

the golf counter mechanism being further characterized in that the first means are mounted so as to move inside the case such that any one of said means can occupy a determined score incrementing/read position, wherein said means is selected to cooperate with the third and fourth means.

Owing to the fact that the means for counting the score at each hole are mounted mobile inside the case, and that each of them can be brought into a position for modifying, reading and displaying the score, the dial of the golf counter according to the invention is not wastefully occupied by the display of the score at each hole, and consequently it can be used for displaying the time. The golf counter according to the invention can thus easily be integrated into a watch. Other features and advantages of the present invention will appear more clearly from the following detailed description of an example embodiment of a watch according to the invention, this example being given purely by way of non-limiting illustration, in conjunction with the annexed drawings, in which:

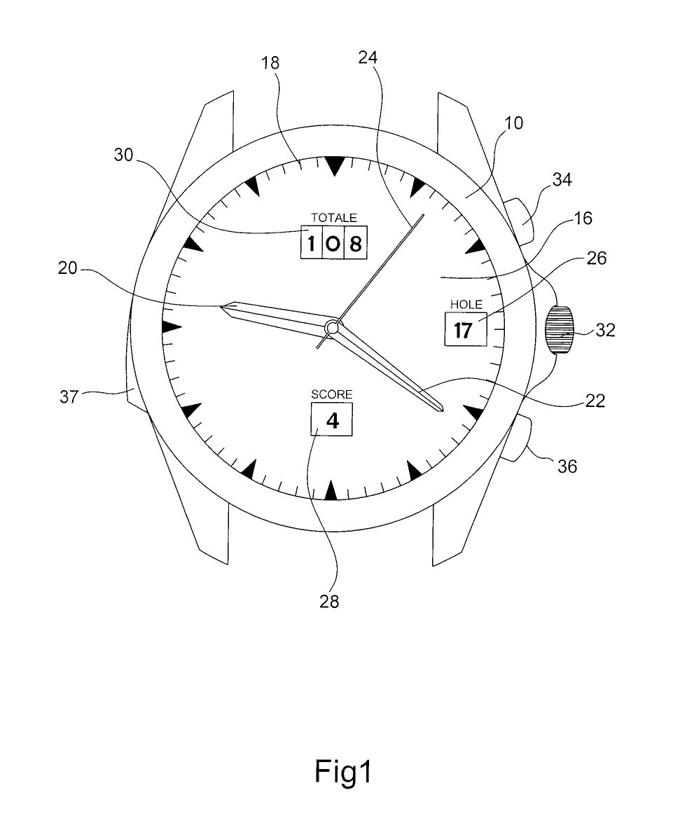

FIG. 1 is a top view of the golf counter according to the invention,

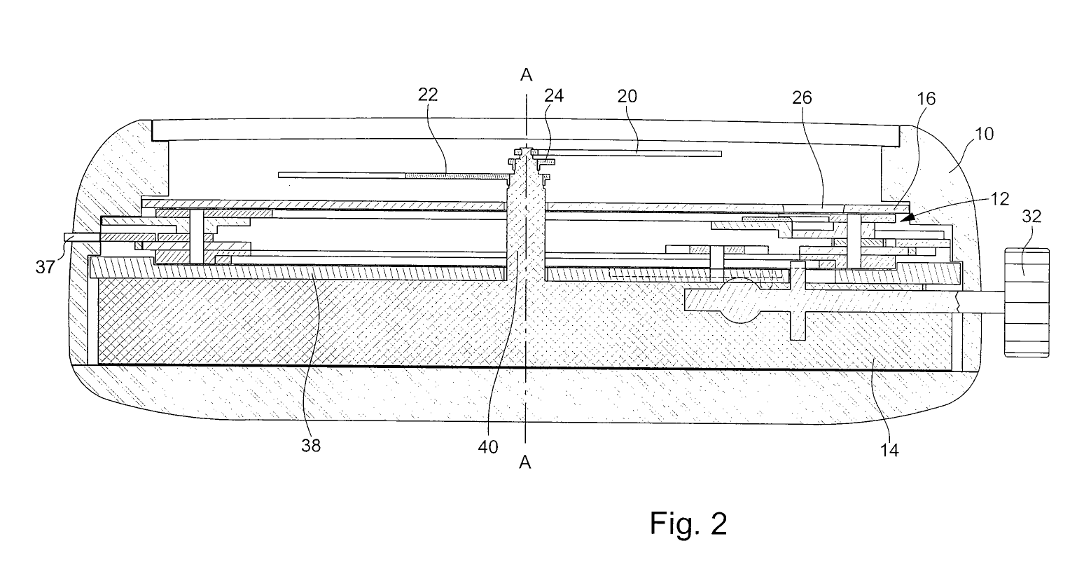

FIG. 2 is a cross-section of the golf counter according to the invention,

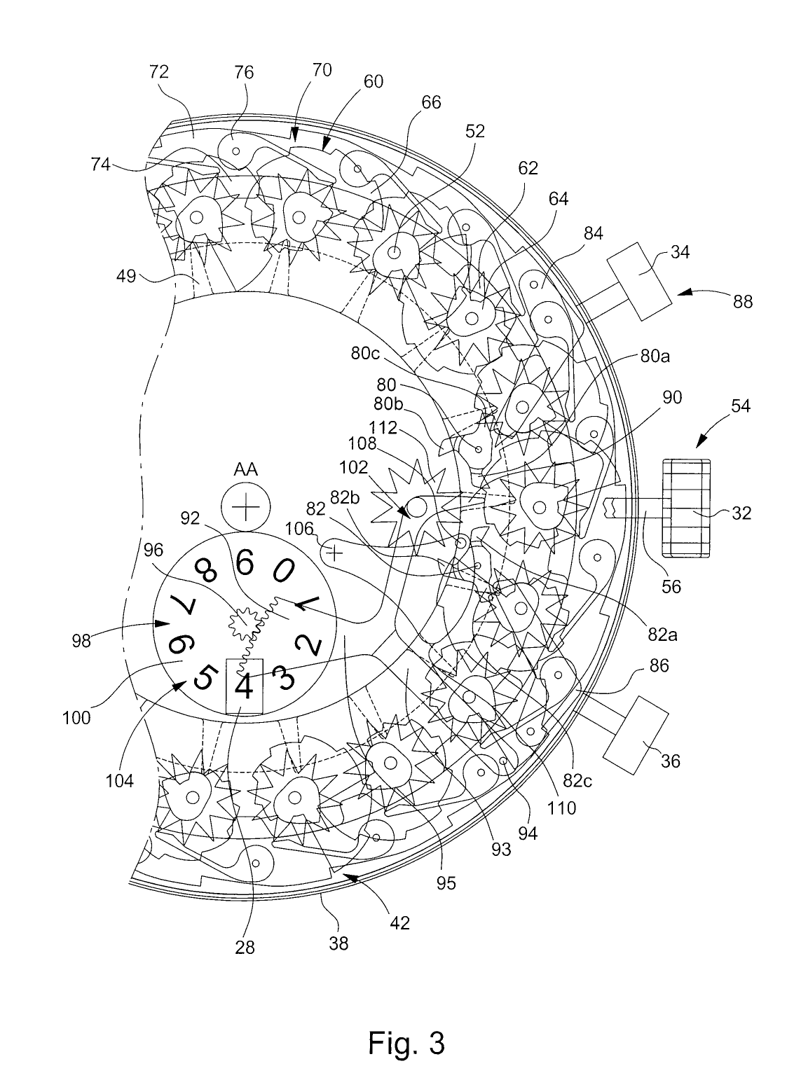

FIG. 3 is a top view of the golf counter mechanism fitted to the golf counter according to the invention, and

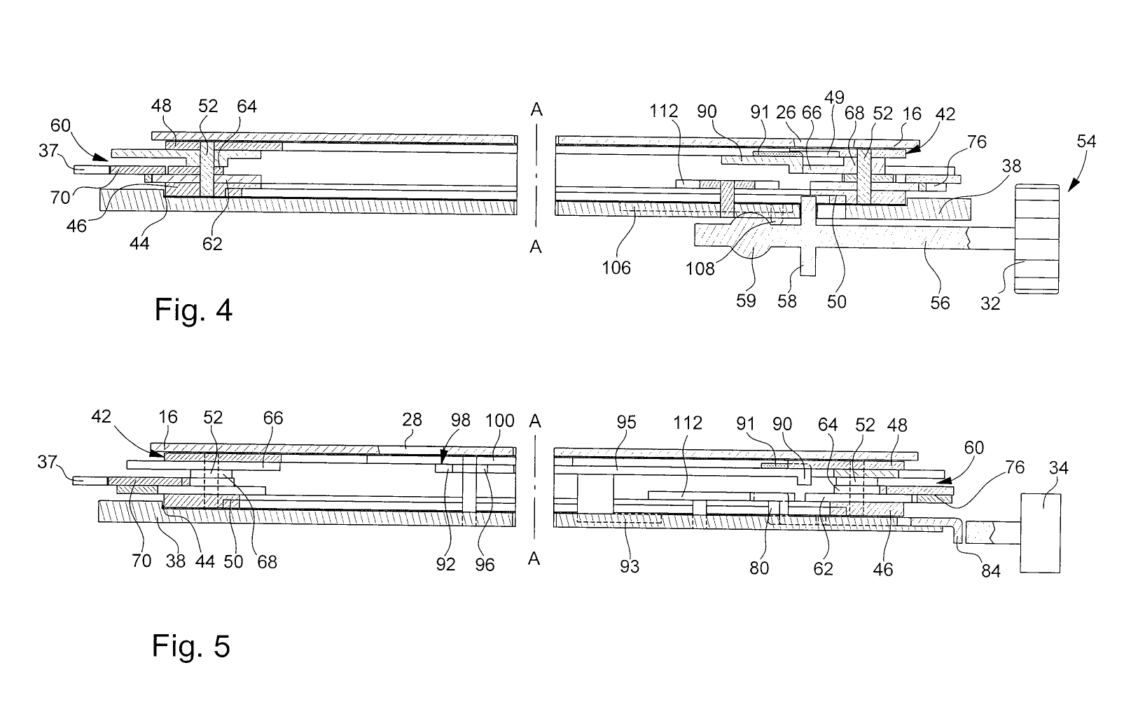

FIGS. 4 and 5 are cross-sections along 9 o'clock-3 o'clock and 2 o'clock-8 o'clock of the mechanism.

The golf counter mechanism illustrated in FIGS. 1 and 2 conventionally comprises a case 10 enclosing a golf counter mechanism 12. In the embodiment shown in FIGS. 1 and 2, the mechanical golf counter further includes a movement 14 above which a dial 16 is mounted, said dial bearing a time display graduation 18 cooperating with hour 20, minute 22 and second 24 hands driven by movement 14. Of course, in a variant of this embodiment, movement 14 could be absent from the golf counter.

The dial 16 includes a first aperture 26 showing a hole number, for example the hole being played, a second aperture 28 corresponding to the score at that hole and a third aperture 30 through which the total score is visible. The case is fitted with a crown 32 located at 3 o'clock for selecting a given hole, two push-buttons 34 and 36 respectively located at 2 o'clock and 4 o'clock, respectively for incrementing and decrementing the score of the selected hole and the total score, and a lever 37 for resetting the score at each hole to zero.

Movement 14 of the mechanical golf counter is conventionally mounted in case 10. Golf counter mechanism 12 is placed above movement 14. For this purpose, it comprises a plate 38 of axis AA fixedly mounted in case 10. In the embodiment illustrated in FIG. 2, plate 38 is secured to case 10. In a variant, plate 38 could be secured to movement 14, which would itself be fixedly mounted in case 10. The dial 16 is mounted above the mechanism 12 said dial 16 being attached to case 10. A central arbour 40 associated with movement 14 and carrying hands 20, 22 and 24 passes through mechanism 12 and dial 16.

Golf counter mechanism 12 is shown in more detail in FIGS. 3, 4 and 5. It comprises the fixed plate 38 of axis AA, and a plate 42 mounted mobile in rotation about axis AA, on fixed plate 38. For this purpose, fixed plate 38 is fitted with a circular housing 44 located on the top face thereof. Moreover, mobile plate 42 is formed of a bottom plate 46 and a top plate 48, both hollowed at the center. Top plate 48, located directly underneath dial 16, bears the hole numbers, visible through aperture 26. It is, further, provided with a plurality of notches 49, distributed on the inner periphery thereof, the function of which will appear hereinbelow. Bottom plate 46 is provided with a contrate toothing 50 located on the bottom face thereof. The bottom and top plates 46 and 48 are secured to each other via a plurality of arbours 52 distributed in a circle and secured by a first end to bottom plate 46, and by a second end to top plate 48. Bottom plate 46 is arranged in a housing 44, such that plate 42 is positioned radially while being guided in rotational movement. Plate 42 is controlled in rotation by a control member 54 located at 3 o'clock and formed of a stem 56 on which the crown 32 and a pinion 58 are mounted. Control member 54 is arranged in case 10 such that pinion 58 meshes with contrate toothing 50 in the pulled out position, and rotates freely in the pushed-in position. Stem 56 extends beyond pinion 58 and further comprises a protruding circular portion 59, the function of which will be explained hereinbelow.

Arbours 52, 18 in number, each correspond to one hole of the golf course and to a number of the numbering of top plate 48. A simplified variant of this embodiment could be limited to 9 arbours, for a 9-hole golf course. On each arbour 52, there is mounted a wheel set 60 formed, from bottom plate 46 to top plate 48, of a star wheel with ten teeth 62, a heart-piece 64 and a snail 66, the various elements being superposed and secured to each other. At the heart of the same wheel set 60, star 62, heart-piece 64 and snail 66 are orientated relative to each other such that the tip of heart-piece 64 is aligned with one tooth of star wheel 62 and the portion of snail 66 with the largest radius. Each snail 66 is further provided with a wedge 68 secured to the bottom face or top face thereof, such that it extends respectively into a top or bottom level. Two neighbouring snails 66 extend into two different levels, which enables wheel sets 60 to be moved closer without snails 66, which form the widest part of wheel set 60, colliding with each other.

A ring 70 is inserted, at the periphery of counter mechanism 12, between star wheels 62 and snails 66, in the plane of heart-pieces 64. It is provided with eighteen symmetrically teeth 72 for cooperating with reset lever 37, as will appear hereinbelow. It comprises, directed towards heart-pieces 64, eighteen protruding portions 74 forming hammers for orientating wheel sets 60 for resetting the score at each hole to zero. Moreover, it is provided with 18 jumper springs 76 secured to the bottom face thereof, each jumper spring 76 cooperating with one star wheel 62 in order to position the same. When plate 42 is being driven in rotation, ring 70 is itself driven in rotation owing to the friction forces exerted by the eighteen star wheels on the eighteen jumper springs.

The wheel set 60 located at 3 o'clock is the wheel set corresponding to the selected hole. In this position, wheel set 60 can be activated in order to increment the score of the selected hole and enable the score to be read. This will be called the incrementing/read position in the following text. In order to increment the score, two respectively incrementing and decrementing wheel sets 80 and 82, each provided with two beaks, respectively 80a, 80b and 82a, 82b and one finger, respectively 80c and 82c, are mounted in fixed plate 38, in proximity to the star wheel 62 located in the incrementing/read position, on either side of the 9 o'clock-3 o'clock diameter. The beaks 80a, 80b, 82a and 82b are located in the plane of star wheel 62, whereas fingers 80c and 82c extend in the plane of fixed plate 38. Wheel sets 80 and 82 are activated by two levers, respectively 84 and 86, pivotably mounted in fixed plate 38. These levers 84 and 86 extend in the plane of fixed plate 38 so as to cooperate respectively with fingers 80c and 82c. They are respectively activated by push-buttons 34 and 36. Push-buttons 34, 36, levers 84, 86 and wheel sets 80, 82 form, with star wheels 62, a device 88 for incrementing/decrementing the score of the selected hole.

Golf counter mechanism 12 further comprises a feeler-spindle 90 that rests on snail 66 in the incrementing/read position. The end thereof extends on the bottom and top levels of snails 66 so as to come into contact with any of them. It further possesses a beak 91 extending into the plane of top plate 48 and for cooperating with notches 49 in order to block mobile plate 42, as will appear hereinbelow. Feeler spindle 90 is secured to a rack 92 pivotably mounted about an arbour 94 in fixed plate 38 and comprising a first portion 93 extending into the plane of plate 38 and a second portion 95 extending into the plane of feeler spindle 90. The assembly of feeler spindle 90-rack 92 is subjected to the action of a return spring that is not shown, tending to hold feeler spindle abutting on the snail 66 in the incrementing/read position. Rack 92 meshes with a pinion 96 mounted in fixed plate 38. Wheel set 98 comprises, in addition to pinion 96, a disc 100 for displaying the score of the selected hole located opposite aperture 28. Feeler spindle 90 forms a device 102 for reading the score of the selected hole, whereas rack 92 forms, with wheel set 98, a device 104 for displaying this score.

A substantially triangular cam 106, extending into the plane of fixed plate 38, is pivotably mounted thereon, It comprises a stop member 108, located on an apex of the triangle and extending axially towards movement 14, and a rounded protruding portion 110 substantially forming another triangle apex and for cooperating with the portion 95 of rack 92. Cam 106 is subjected to the action of a return spring that is not shown, tending to keep stop member 108 abutting against the stem 56 of control member 54. In this position, protruding portion 110 does not come into contact with rack 92, whatever the position of the latter.

Golf counter mechanism 12 includes finally a star wheel 112 mounted in fixed plate 38 in proximity to star wheel 62 in the incrementing/read position, on the 9 o'clock-3 o'clock diameter, and extending into the plane of star wheel 62. In this position, star wheel 112 can be actuated by beak 80b and 82b of wheel sets 80 and 82 respectively. Star wheel 112 forms the first element of an adder that is not shown, of the type disclosed in GB Patent No. 310 401. The adder is associated with a display device for displaying the total score through aperture 30. Mechanism 12 also includes, optionally, a device for resetting the score to zero, of the type presented in GB Patent No. 310 401.

Golf counter mechanism 12 operates as follows:

In the initial position, the wheel set 60 corresponding to the first hole is in the incrementing/read position, and hole number 1 can be seen through aperture 26. Moreover, wheel sets 60, which provided, via their angular position, an indication of the hole score, are orientated such that snail 66 points towards the AA axis, which corresponds to a score of zero. In this position, aperture 28, associated with the score of the selected hole, display a score of zero. Likewise, aperture 30 associated with the total score, displays a score of zero. It will also be noted that the rotating plate 42 is blocked in rotation owing to beak 91, which is engaged in the notch 49 of plate 48 corresponding to this initial position.

An application of pressure on push-button 34 activates lever 84, which drives incrementing wheel set 60 in rotation via finger 80c. Beak 80a abuts on one tooth of star wheel 62 in the incrementing/read position, and the latter rotates by one tooth via jumper spring 76. The score of the selected hole, which is linked to the angular position of wheel set 60, is thus incremented by one point. At the same time, beak 80b abuts on one tooth of star wheel 112, and the latter rotates by one tooth, driving the adder. The total score is thus incremented by one point.

In the initial position, feeler spindle 90 abuts on the portion of snail 66 that has the largest radius in the incrementing/read position. When wheel set 60 rotates via the effect of an application of pressure on push-button 34, snail 66 presents a smaller radius to feeler spindle 90, which causes the feeler spindle 90-rack 92 assembly to swing about its pin 94. Rack 92 in turn drives wheel set 98 in rotation via pinion 96 and the display of the first hole score passes from 0 to 1.

Repeated applications of pressure on push-button 34 thus increment and display the score of the first hole and the total score. It will be noted that it is possible to correct these scores via push-button 36. Indeed, the action of push-button 36, associated with lever 86 and wheel set 82, is symmetrical with the action of push-button 34. Push-button 36 thus rotates star wheels 62 and 112 in the opposite direction to the incrementing direction, which decrements the scores.

Passage from the first hole to the second hole is achieved by using control member 54 in the pulled-out position. In this position, protruding portion 59 present on stem 56 is positioned opposite the stop member 108 belonging to cam 106, which has the effect of pivoting cam 106 about its axis. Protruding portion 110 then abuts on rack 92 so as to cause it to pivot about its axis 94. Feeler spindle 90 is thus moved away from snail 66, and beak 91 leaves notch 49, which unblocks plate 42. When the operator activates control member 54, mobile plate 42 is driven in rotation and the wheel set 60 corresponding to the second hole is brought into the incrementing/read position. Aperture 26 then shows the number 2, and a score of zero is displayed through the aperture 28 associated with the score of the selected hole. The second hole score and total score are altered using push-buttons 34 and 36 as explained previously.

The operations described previously are then repeated until the last hole.

It should be noted that as the angular position of wheel sets 60 is fixed, owing to jumper springs 76, the score at each hole played is stored when the user passes to the next hole. It is thus possible, at any time, to consult the score of a hole that has already been played, by moving plate 42 using crown 32 so as to position a determined wheel set 60 in the incrementing/read position. Since the score has been stored using jumper spring 76, feeler spindle 90 reads this score and transmits it to display device 104.

At the end of a round, the scores of the holes played are reset to zero using ring 70. This latter is activated using the zero reset lever 37, which cooperates with the asymmetrical teeth 72 to drive the lever in rotation. Hammers 74 then return all of heart-pieces 64 to their initial position, i.e. with the point thereof pointed towards the AA axis. Wheel sets 60 are thus all reoriented so as to provide a zero score reading.

1. A mechanical golf counter including a case in which is mounted a golf counter mechanism including:
(a) a plurality of first means for counting a score associated with a plurality of holes, and able to provide an indication of the score at each hole;
(b) a plurality of second means able to store said indication for each hole, and cooperating with said first means;
(c) third means able to alter the score indication of a selected hole, said third means cooperating with said first means;
(d) fourth means able to read the score of said selected hole, said fourth means cooperating with said first means; and
(e) fifth means able to display the score of said selected hole, said fifth means cooperating with said fourth means,
wherein said first means are mounted mobile inside the case so that any one of said means can occupy a determined score incrementing/read position, in which said means is selected to cooperate with said third and fourth means.

2. The mechanical golf counter according to claim 1, wherein said first means are formed of wheel sets each providing an indication of the score at one hole, and wherein said wheel sets are mounted on a first plate being mounted mobile in rotation inside the case so as to cause the wheel sets to pass in succession into said determined incrementing/read position.

3. The mechanical golf counter according to claim 2, wherein said first plate is actuated by a rotation control member.

4. The mechanical golf counter according to claim 2, wherein said golf counter mechanism further includes a second plate fixedly mounted in the case and on which said first plate is mounted so as to move in rotation.

5. The mechanical golf counter according to claim 2, wherein said wheel sets include a star wheel and a snail secured to said star wheel.

6. The mechanical golf counter according to claim 5, wherein said third means able to alter the score indication of a selected hole include an incrementing wheel set fixedly mounted on said second plate and provided with a beak cooperating with said wheel set in the incrementing/read position, a first lever pivotably mounted on said second plate and cooperating with said incrementing wheel set so as to rotate the same, and a first push-button mounted in said case and cooperating with said first lever so as to pivot the same.

7. The mechanical golf counter according to claim 5, wherein said fourth means able to read the score of said selected hole include a feeler spindle pivotably mounted on said second plate and cooperating with said snail in the incrementing/read position.

8. The mechanical golf counter according to claim 7, wherein said fifth means able to display the score of said selected hole include a rack secured to said feeler spindle, and a wheel set formed of a pinion and a display disc, said rack meshing with said pinion.

9. The mechanical golf counter according to claim 5, wherein said second means able to store said indication for each hole include a plurality of elastic members cooperating with said star wheels so as to position the same.

10. The mechanical golf counter according to claim 5, wherein said wheel sets further include a heart piece inserted between said star wheel and said snail and secured to said star wheel and to said snail.

11. The mechanical golf counter according to claim 10, wherein said elastic members are mounted on a ring inserted between said star wheels and said snails, said ring further including a plurality of hammers cooperating with said heart pieces so as to orientate the same.

12. The mechanical golf counter according to claim 7, wherein said feeler spindle further includes a beak and wherein said first plate includes a plurality of notches, said beak cooperating with said notches so as to block said first plate in rotation.

13. The mechanical golf counter according to claim 2, wherein said first plate rotatably mounted inside said case is provided with a contrate toothing, and wherein said control member includes a stem, a crown mounted on a first end of said stem and a pinion mounted on a second end of said stem, said pinion meshing with said contrate toothing.

14. The mechanical golf counter according to claim 1, wherein said golf counter mechanism further includes an adder.

15. The mechanical golf counter according to claim 1, wherein said golf counter mechanism further includes means for decrementing the score provided by said wheel set in the incrementing/read position.

16. The mechanical golf counter according to claim 15, wherein said decrementing means include a decrementing wheel set fixedly mounted on said second plate and fitted with a beak cooperating with said star wheel in the incrementing/read position, a second lever pivotably mounted on said second plate and cooperating with said decrementing wheel set so as to rotate the same, and a second push-button mounted in said case and cooperating with said second lever so as to pivot the same, said decrementing means, second lever and second push-button being symmetrically mounted relative to the wheel set in the incrementing/read position or respectively to the incrementing wheel set, first lever and first push-button.

17. The mechanical golf counter according to claim 1, further including a movement mounted in said case.

18. The mechanical golf counter according to claim 3, wherein said golf counter mechanism further includes a second plate fixedly mounted in the case and on which said first plate is mounted so as to move in rotation.

19. The mechanical golf counter according to claim 3, wherein said wheel sets include a star wheel and a snail secured to said star wheel.

20. The mechanical golf counter according to claim 4, wherein said wheel sets include a star wheel and a snail secured to said star wheel.
